(19) United States
(12) Patent Application Publication
(10) Pub. No.: US 2011/0296207 A1
(43) Pub. Date: Dec. 1, 2011

(54) Combinative encryption flash disk

(75) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 12/805,492

(22) Filed: Aug. 3, 2010

(30) Foreign Application Priority Data
May 28, 2010 (TW) 099117243

(51) Int. Cl. G06F 12/14

(52) U.S. Cl. 713/193

(57) ABSTRACT

A combinative encryption flash disk with two data disks and an encryption system at least for digital data encrypted and accessed via an operating system is characteristic of (1) Function of keeping digital data secret and safe; (2) Consumer's reduced cost and a specific plug-in sequence for a promoted secrecy function by two cascaded data disks at least plugged into a single port; (3) Plain interface and simple operation in favor of one user configuring and operating.

### BACKGROUND OF THE INVENTION

1) Field of the Invention

The present invention relates to a storage device, especially to a structure and a system of a combinative encryption flash disk and a method of operating a combinative encryption flash disk.

2) Description of the Prior Art

Prosperous information and progressive technologies have embodied more and more digital data stored in various storage devices such as USB flash disk and mobile hard disk wherein the USB flash disk with advantages like handiness, portability, and plug-and-play is the most popular with the general public.

However, being short of a function to conceal stored digital data, a conventional USB flash disk with a problem of stored digital data easily stolen may allow its digital data or even trade secrets to be exposed in case of the disk held by other people.

Furthermore, the number of USB ports provided in one host computer is gradually insufficient due to more and more USB connectors built in existing electronic products. For a USB flash disk, it is inevitable to increase cost and inconvenience of one consumer who cannot help but purchase a multi-port connector beforehand in which digital data is accessed by an identical USB port connected to not less than one USB flash disk despite an extra multi-port connector added to a single USB port of one host computer with a USB flash disk only plugged originally for digital data in multiple USB flash disks accessed by a single USB port.

### SUMMARY OF THE INVENTION

For the purpose of solving the said problem, the principal object of the present invention is to provide a combinative encryption flash disk to embody a function of keeping digital data secret and safe by cascading not less than two data disks without worry about potential exposure of digital data in one data disk held by another person.

The other object of the present invention is to provide a combinative encryption flash disk plugged into a single port by cascading not less than two data disks, and to reduce a consumer's cost and further promote secrecy.

The further object of the present invention is to provide a combinative encryption flash disk with a plain interface and a simple operation in favor of one user configuring and operating.

To reach the said objects hereinabove, a principal technical measure adopted in the present invention is shown as follows. Embodying digital data encrypted and accessed via an operating system, the present invention of a combinative encryption flash disk comprises two data disks and an encryption system at least wherein the data disk's substrate has both an outer surface with a plurality of contact fingers at one end and with a plurality of adapter fingers at the other end and an inner surface provided with a memory chip at least which is electrically connected to the contact fingers as well as the adapter fingers; an encryption system stored in the memory chip comprises a public zone at least storing public digital data, a private zone at least storing private digital data, a public program with a sequence configure module determining a sequence of the data disks plugged sequentially and a capacity configure module regulating a relative capacity of the public zone and the private zone.

The objects of the present invention and the technical issues can be further embodied with the following technical measures.

In the said combinative encryption flash disk, the capacity configure module is provided with a capacity configure interface which is used to regulate a relative capacity of the public zone and the private zone and is exported to an electronic data exchange device.

In the said combinative encryption flash disk, the sequence configure module is provided with a sequence configure interface which is used to decide a sequence of the data disks plugged sequentially and is exported to an electronic data exchange device.

In the said combinative encryption flash disk, the public program comprises a time configure module which is one timing mechanism to decide time intervals for the data disks plugged into the electronic data exchange device as well as each of the data disks sequentially plugged and is provided with a time configure interface exported to an electronic data exchange device.

In the said combinative encryption flash disk, the public program comprises a password configure module which is used in key-in and cancel of a password and is provided with a password configure interface exported to an electronic data exchange device.

In the said combinative encryption flash disk, the capacity configure interface, the sequence configure interface, and the time configure interface are integrated into an identical operation interface or any of distinct operation interfaces for performance of each configure.

In the said combinative encryption flash disk, the public program is installed to a single data disk or distributed in one of a plurality of data disks at least.

In the said combinative encryption flash disk, the contact fingers are provided with metal contacts which are compatible to one of the following data transfer interfaces at least such as Universal Serial Bus (USB), Mini Universal Serial Bus (Mini USB), Micro Universal Serial Bus (Micro USB), or External Serial Advanced Technology Attachment (e-SATA).

The present invention of a combinative encryption flash disk with a method for digital data encrypted and accessed includes the following steps. Step 1: two data disks at least provided; Step 2: data disks plugged into an electronic data exchange device and sequentially and properly connected each other; Step 3: operation interface enabled; Step 4: relative capacity of the public zone and the private zone regulated via the operation interface's capacity configure interface; Step 5: configuration completed.

After Step 3 of the operation methods hereinabove, a sequence of the data disks, time intervals of the data disks sequentially plugged, and key-in as well as cancel of a password can be regulated or configured via the sequence configure interface, the time configure interface, and the password configure interface, respectively.

In contrast to prior arts, the present invention is effective in (1) Function of keeping digital data secret and safe by cascading two data disks at least without worry about potential exposure of digital data in a data disk held by another person; (2) Consumer's reduced cost and a specific plug-in sequence for a promoted secrecy function by two cascaded data disks at least plugged into a single port; (3) Plain interface and simple operation in favor of one user configuring and operating.

### BRIEF DESCRIPTIONS OF THE DRAWINGS

FIG. 1 is a perspective view in the present invention of a combinative encryption flash disk.

FIG. 2 is the first sectional view in the present invention of a combinative encryption flash disk structure.

FIG. 3 is a block diagram of components in the present invention of a combinative encryption flash disk.

FIG. 4 is the second sectional view in the present invention of a combinative encryption flash disk structure.

FIG. 5 is a block diagram of components in the first embodiment of the present invention.

FIG. 6 is a schematic diagram of the capacity configure interface in the first embodiment of the present invention.

FIG. 7 is a schematic diagram of the sequence configure interface in the first embodiment of the present invention.

FIG. 8 is a flow diagram of operating steps in the first embodiment of the present invention.

FIG. 9 is block diagram of components in the second embodiment of the present invention.

FIG. 10 is a schematic diagram of the time configure interface in the second embodiment of the present invention.

FIG. 11 is a flow diagram of operating steps in the second embodiment of the present invention.

FIG. 12 is a block diagram of components in the third embodiment of the present invention.

FIG. 13 is a schematic diagram of the password configure interface in the third embodiment of the present invention.

FIG. 14 is a flow diagram of operating steps in the third embodiment of the present invention.

### DETAILED DESCRIPTIONS OF THE PREFERRED EMBODIMENTS

For objects, characteristics, and effects obviously and easily understood, the preferred embodiments of the present invention are particularly interpreted as follows:

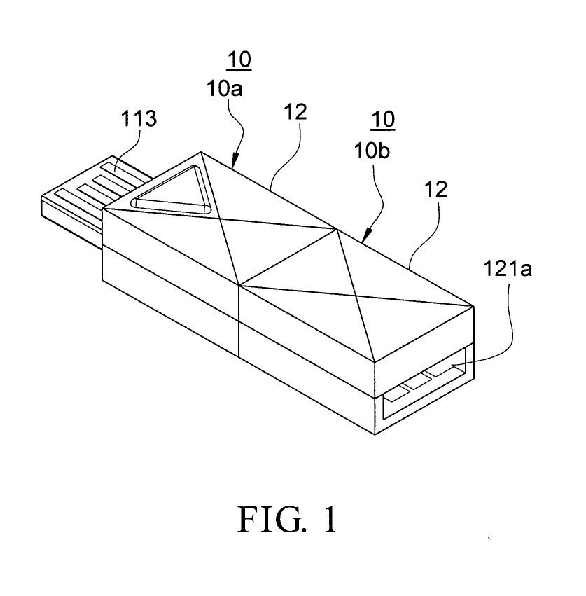

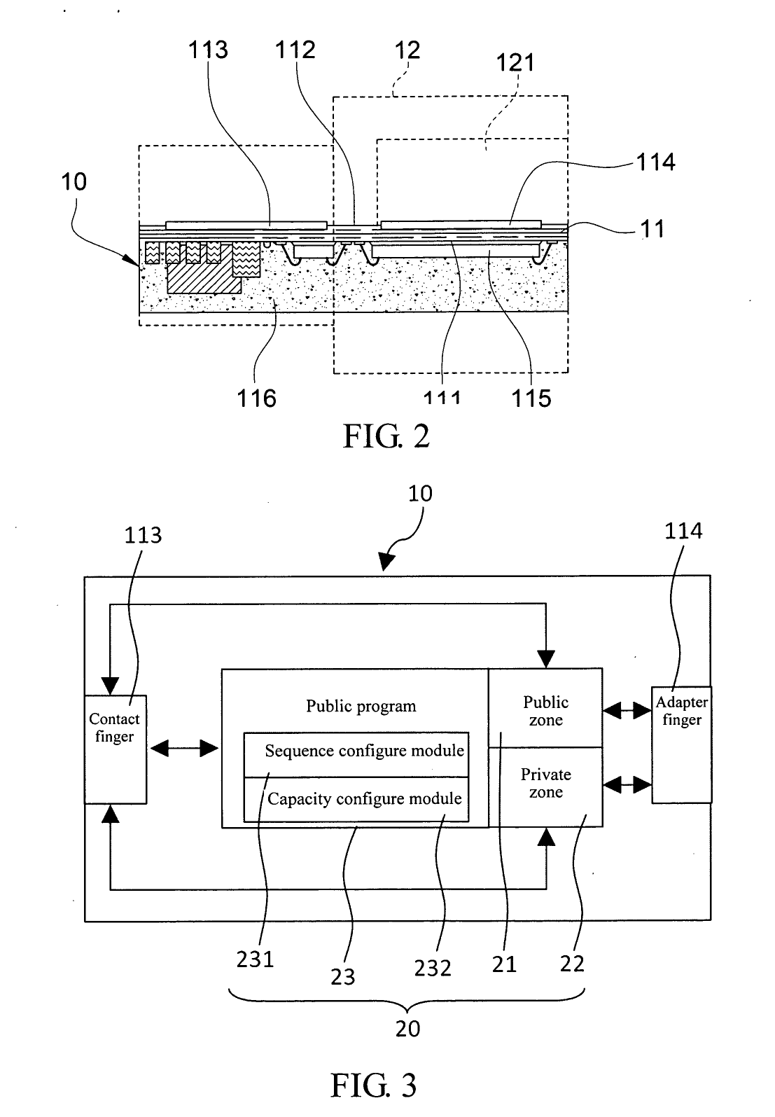

As shown from FIG. 1 to FIG. 8, the manner and steps as regards the first embodiment to encrypt and access digital data in the present invention of a combinative encryption flash disk are embodied via an operating system. Referring to FIG. 1, FIG. 2, and FIG. 3 first which illustrate the combinative encryption flash disk comprises two data disks (10) and an encryption system (20) at least wherein a substrate (11) of the data disk (10) has both an inner surface (111) provided with a memory chip (115) at least, which is electrically connected to contact fingers (113) as well as adapter fingers (114) and electrically connected to the substrate (11) by wire bonding or a flip chip technique, and an outer surface (112) with a plurality of contact fingers (113) at one end and a plurality of adapter fingers (114) at the other end. Preferably, a package (116) is developed on the inner surface (111) of the substrate (11) to encapsulate the memory chip (115). Preferably, the data disk (10) comprises a case (12) with a plurality of adapter fingers (114) included and a plug-in space (121) developed above a plurality of adapter fingers (114). Preferably, a plurality of contact fingers (113) are compatible to one of the following data transfer interfaces at least such as Universal Serial Bus (USB), Mini Universal Serial Bus (Mini USB), Micro Universal Serial Bus (Micro USB), or External Serial Advanced Technology Attachment (e-SATA).

Referring to FIG. 2 and FIG. 3 which further illustrate an encryption system (20) stored in the memory chip (115) comprises a public zone (21), a private zone (22), and a public program (23) at least wherein the public zone (21) and the private zone (22) are used to store public digital data and private digital data, respectively, and the public program (23) has both a sequence configure module (231) which decides a sequence of the data disks (10) sequentially plugged and a capacity configure module (232) which regulates a relative capacity of the public zone (21) and the private zone (22). Preferably, the public program (23) is installed in a single data disk or distributed in one of a plurality of data disks at least. In this embodiment, the public program (23) is written in a single data disk (10).

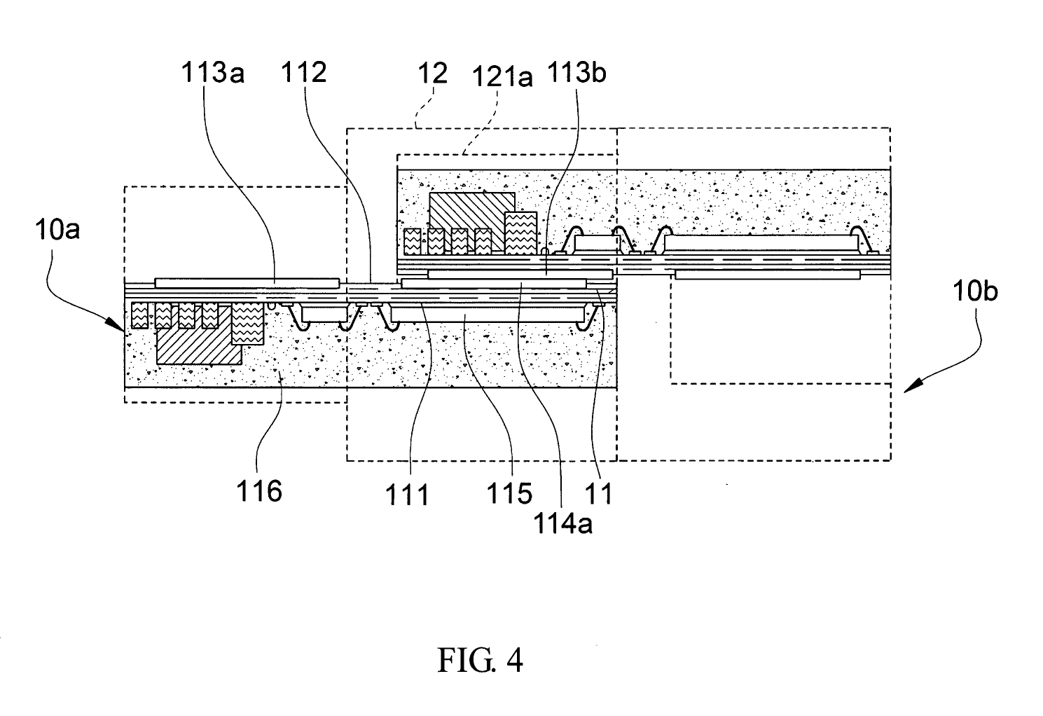

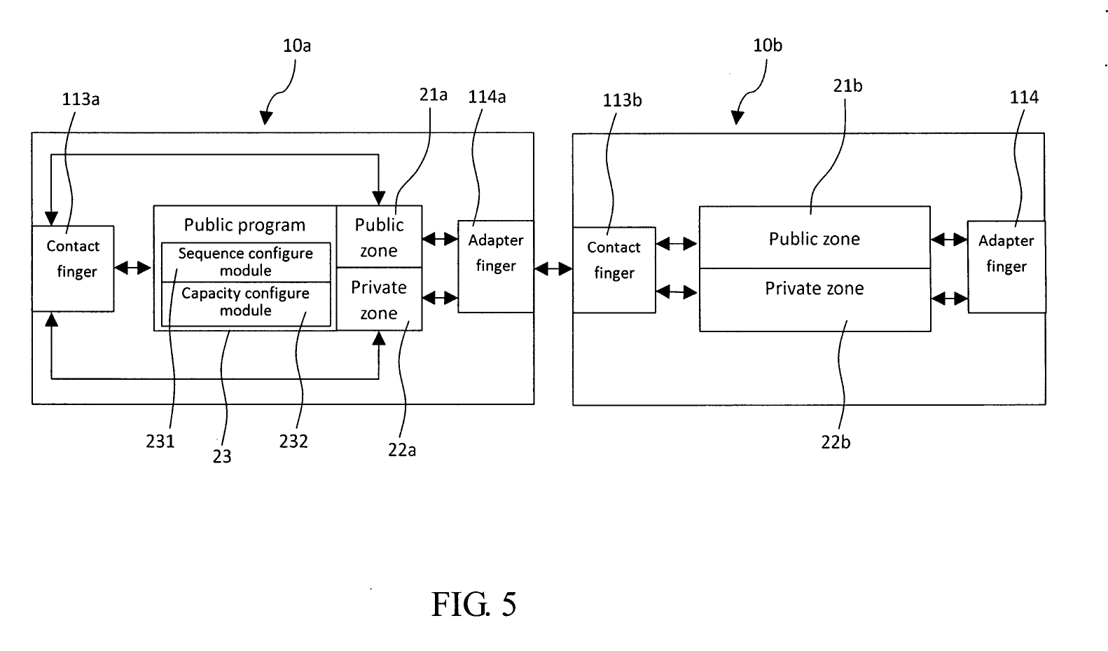

Referring to FIG. 4 and FIG. 5 which practically illustrate an embodiment with a data disk I (10a) and a data disk II (10b) in which the number of data disks is not restricted in the present invention. In this embodiment, the sequence configure module (231) configures a USB data transfer interface on the data disk I (10a) electrically connected to an electronic data exchange device's USB port (not shown in both figures) in advance, and then decides a sequence of a data disk II (10b) electrically connected to the data disk I (10a). During a connection performed, a plurality of contact fingers (113a) of the data disk I (10a) with a USB data transfer interface are electrically connected to an electronic data exchange device's USB port (not shown in both figures); then a plurality of contact fingers (113b) of the data disk II (10b) are plugged into a plug-in space (121a) of the data disk I (10a) and a plurality of contact fingers (113b) of the data disk II (10b) are electrically connected to a plurality of adapter fingers (114a) of the data disk I (10a), that is, the adapter fingers (114a) of the data disk I (10a) as expanded terminals of the contact fingers (113a) are electrically connected to the contact fingers (113b) of the data disk II (10b). Accordingly, in the case of a plug-in action meeting a pre-configuration of the sequence configure module (231), the capacity configure module (232) is enabled to display files stored in private zones (22a, 22b). In the case of a plug-in action not meeting a pre-configuration of the sequence configure module, files stored in public zones (21a, 21b) only rather than files stored in private zones (22a, 22b) and kept as secret can be read by one user.

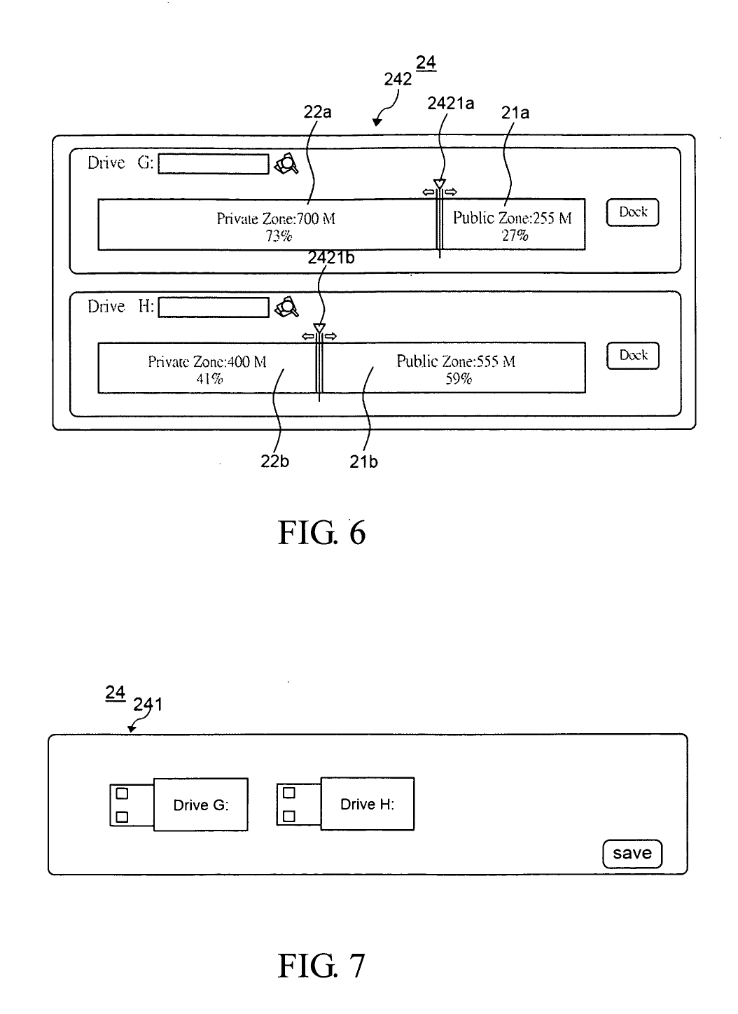

Preferably, referring to FIG. 6 which illustrates a capacity configure module (232) which regulates a relative capacity of the public zones (21a, 21b) and the private zones (22a, 22b), and preferably the capacity configure interface (242) is exported to an electronic data exchange device. Preferably, the relative capacity of private zones and public zones in the data disk I (Drive G:) and a data disk II (Drive H:) can be regulated by drag-and-drop utilities (2421a, 2421b) of the capacity configure interface (242) held with one user's mouse.

Preferably, referring to FIG. 7 which further illustrates the sequence configure module (231) decides a sequence of the data disk I (Drive G:) or the data disk II (Drive H:) plugged by a sequence configure interface (241). Preferably, the sequence configure interface (241) is exported to an electronic data exchange device. As a result, a sequence of data disks plugged can be changed to further increase a secrecy function according to requirements in use when the sequence configure module (231) is enabled by one user who follows a predetermined plug-in sequence. In addition, the capacity configure interface (242) and the sequence configure interface (241) can be integrated into an identical operation interface (24) or any of distinct operation interfaces for performance of each configure. Moreover, the capacity configure interface (242) and the sequence configure interface (241) are not restricted in this embodiment and any equivalent change meeting the present invention should not depart from claims of the present invention.

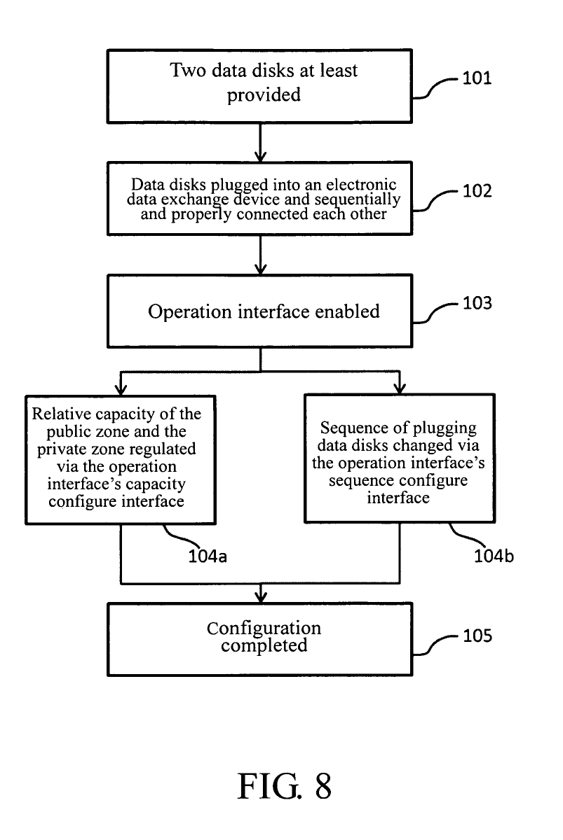

Referring to FIG. 8 which illustrates an operating procedure for digital data encrypted and accessed in the present invention of a combinative encryption flash disk is shown as follows: Two data disks at least provided (101); data disks plugged into an electronic data exchange device and sequentially and properly connected each other (102); operation interface enabled (103); relative capacity of the public zone and the private zone regulated via the operation interface's capacity configure interface (104a); sequence of plugging data disks changed via the operation interface's sequence configure interface (104b); configuration completed (105).

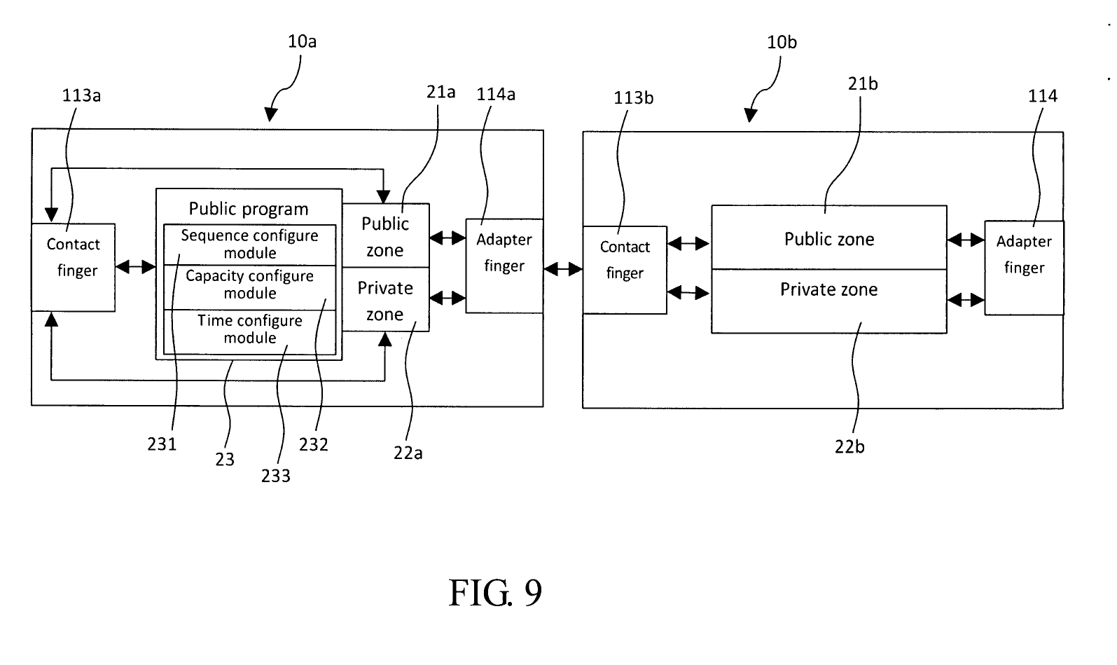

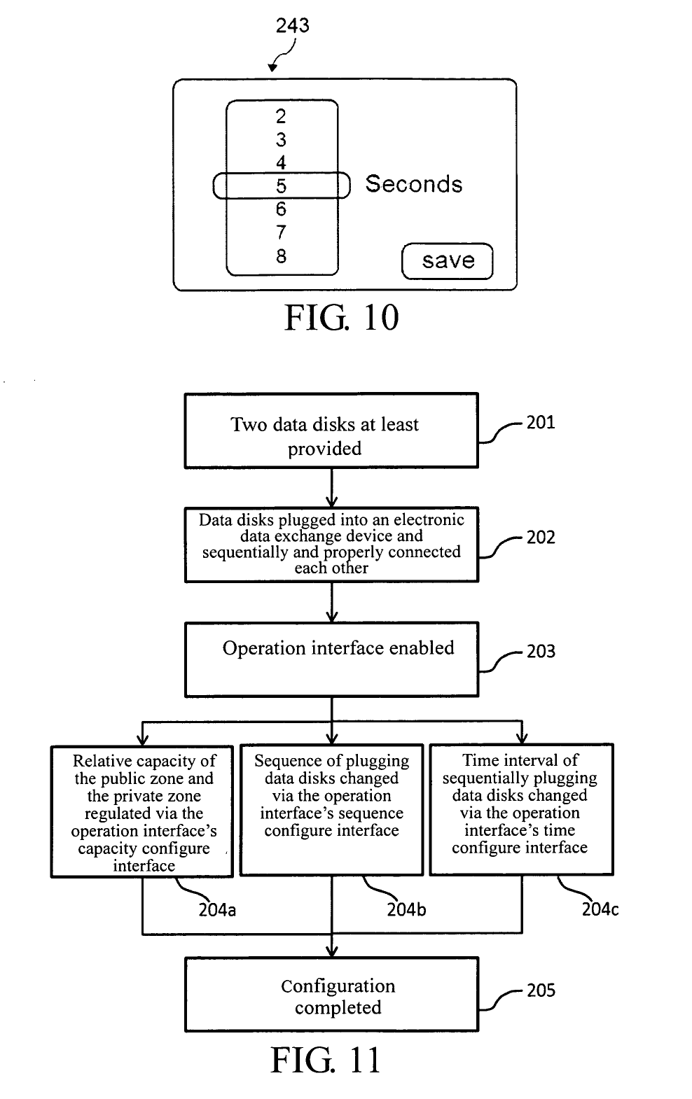

Referring to FIG. 9, FIG. 10, and FIG. 11 which illustrate the second embodiment in the present invention of a combinative encryption flash disk has similar components which have been interpreted in the first embodiment of the combinative encryption flash disk from FIG. 1 to FIG. 8, and are marked with symbols identical to those in FIG. 9, FIG. 10, and FIG. 11 or omitted and thus not described again. Referring to FIG. 9 and FIG. 10 which illustrate a difference between the second embodiment and the first embodiment is a public program (23) comprising a time configure module (233) that decides time intervals of both the data disk I (10a) plugged into an electronic data exchange device's USB port (not shown in both figures) and the data disk II (10b) plugged into the data disk I (10a), and preferably the time configure interface (243) is exported to the electronic data exchange device. Accordingly, a time interval of data disks sequentially plugged can be changed according to one user's requirements with the sequence configure module (231) enabled by a user's predetermined plug-in sequence, for instance, private zones (22a, 22b) to promote a secrecy function by one user's configuration to complete a connection of the data disk I and a USB port as well as a connection of the data disk I and the data disk II in 5 seconds can be observed when both a plug-in sequence and a plug-in time interval are correct. Furthermore, the capacity configure interface (242), the sequence configure interface (241), and the time configure interface (243) can be integrated into an identical operation interface (24) or any of distinct operation interfaces for performance of a predetermined operation. Additionally, the capacity configure interface (242), the sequence configure interface (241), and the time configure interface (243) are not restricted in the embodiment and any equivalent change matching the present invention should be included in claims of the present invention.

Referring to FIG. 11 which illustrates an operating procedure of the second embodiment for digital data encrypted and accessed in the present invention of a combinative encryption flash disk is shown as follows: Two data disks at least provided (201); data disks plugged into an electronic data exchange device and sequentially and properly connected each other (202); operation interface enabled (203); relative capacity of the public zone and the private zone regulated via the operation interface's capacity configure interface (204a); sequence of plugging data disks changed via the operation interface's sequence configure interface (204b); time interval of sequentially plugging data disks changed via the operation interface's time configure interface (204c); configuration completed (105).

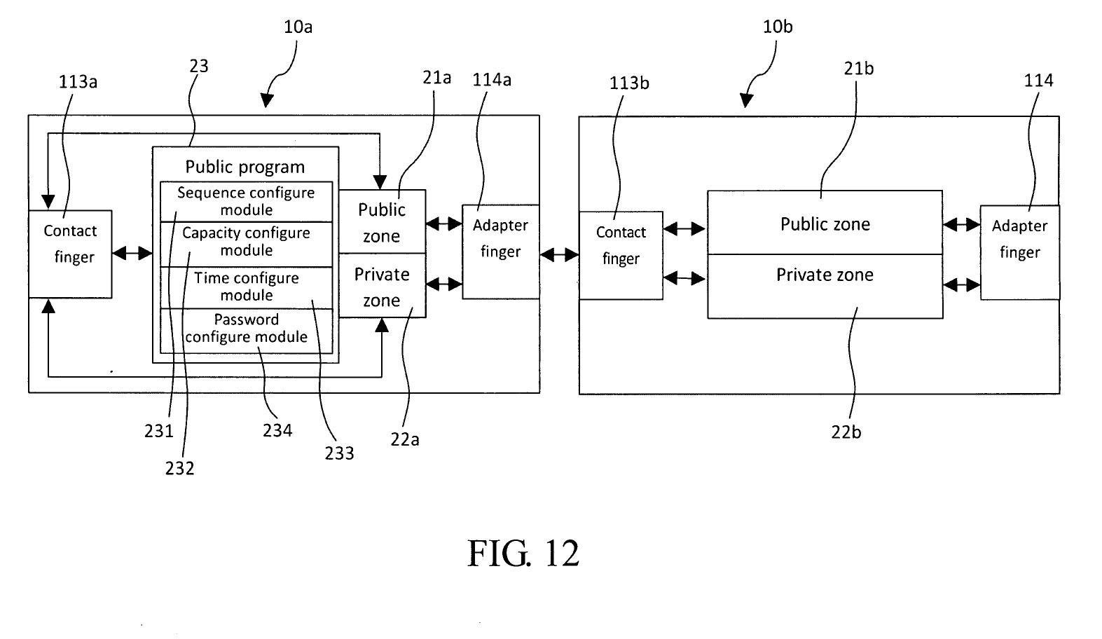

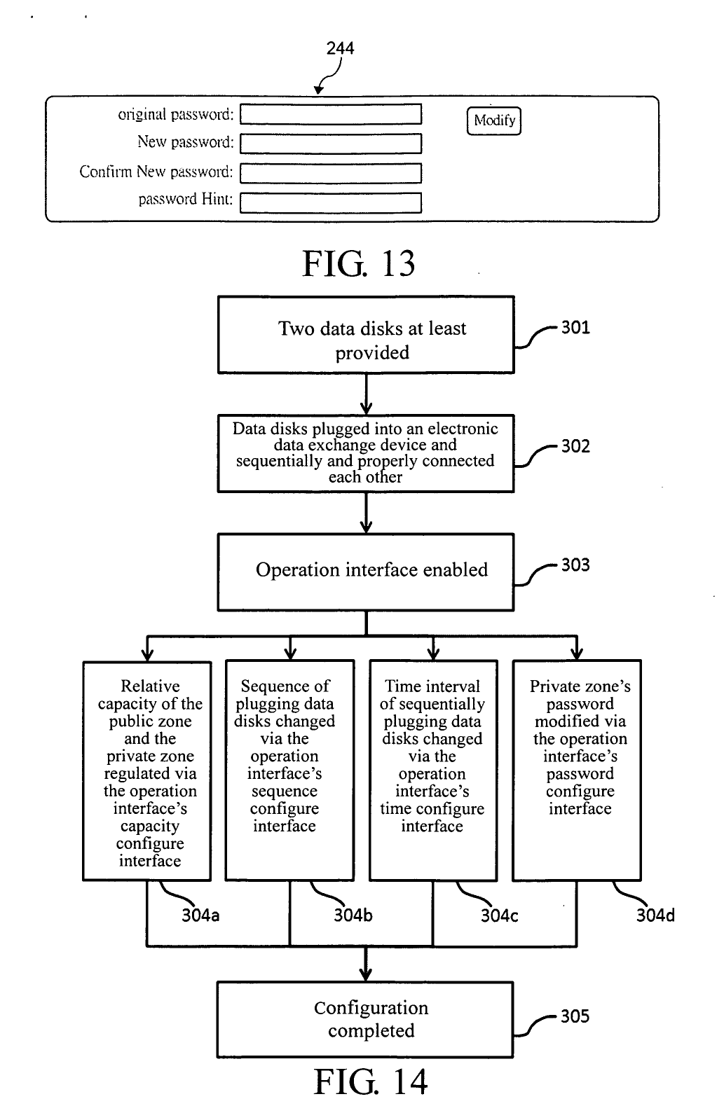

Referring to FIG. 12, FIG. 13, and FIG. 14 which illustrate the third embodiment of the present invention of a combinative encryption flash disk has similar components which have been interpreted in the first and the second embodiments of the combinative encryption flash disk from FIG. 1 to FIG. 11, and are marked with symbols identical to those from FIG. 12 to FIG. 14 or omitted and thus not described again. Referring to FIG. 12 and FIG. 13 first which illustrate a difference between the third embodiment and the second embodiment is a public program (23) comprising a password configure module (234) in which a private zone's password can be canceled or modified by key-in through a password configure interface (244), and preferably the password configure interface (244) is exported to the electronic data exchange device. Accordingly, private zones (22a, 22b) can be observed by one user who keys in a password through the password configure interface (244) for a promoted secrecy function when both a plug-in sequence and a plug-in time interval are correct. Additionally, the capacity configure interface (242), the sequence configure interface (241), the time configure interface (243), and the password configure interface (244) can be integrated into an identical operation interface (24) or any of distinct operation interfaces for performance of each configure. Furthermore, the capacity configure interface (242), the sequence configure interface (241), the time configure interface (243), and the password configure interface (244) are not restricted in the embodiment and any equivalent change matching the present invention should not depart from claims of the present invention.

Referring to FIG. 14 which illustrates an operating procedure for digital data encrypted and accessed in the third embodiment of the present invention is shown as follows: Two data disks at least provided (301); data disks plugged into an electronic data exchange device and sequentially and properly connected each other (302); operation interface enabled (303); relative capacity of the public zone and the private zone regulated via the operation interface's capacity configure interface (304a); sequence of plugging data disks changed via the operation interface's sequence configure interface (304b); time interval of sequentially plugging data disks changed via the operation interface's time configure interface (304c); private zone's password modified via the operation interface's password configure interface (304d); configuration completed (105).

With the above descriptions summarized, the present invention comprising two data disks and an encryption system at least in which digital data can be encrypted and accessed via an operating system is characteristic of (1) Function of keeping digital data secret and safe by cascading two data disks at least without worry about potential exposure of digital data in a data disk held by another person; (2) Consumer's reduced cost and a specific plug-in sequence for a promoted secrecy function by two cascaded data disks at least plugged into a single port; (3) Plain interface and simple operation in favor of one user configuring and operating. Therefore, the present invention different from general conventional flash disks but regarded as creative work meets patentability and is applied for the patent.

The foregoing disclosure and description are illustrative and explanatory of preferred embodiments only and therefore any equivalent change in the instruction, claims, or drawings of the present invention does not depart from claims of the present invention.

What is claimed is:

1. A combinative encryption flash disk for digital data encrypted and accessed via an operating system comprising:
Two data disks at least wherein a substrate of the data disk has both an outer surface with a plurality of contact fingers at one end as well as a plurality of adapter fingers at the other end and an inner surface provided with a memory chip at least electrically connected to the contact fingers as well as the adapter fingers;
An encryption system stored in the memory chip comprising:
A public zone at least used to store public digital data;
A private zone at least used to store private digital data;
A public program with both a sequence configure module used to determine a sequence of the data disks plugged sequentially and a capacity configure module used to regulate a relative capacity of the public zone and the private zone.

2. The combinative encryption flash disk according to claim 1 wherein the capacity configure module is provided with a capacity configure interface which is used to regulate a relative capacity of the public zone and the private zone and is exported to an electronic data exchange device.

3. The combinative encryption flash disk according to claim 1 wherein the sequence configure module is provided with a sequence configure interface which is used to decide a sequence of the data disks plugged sequentially and is exported to an electronic data exchange device.

4. The combinative encryption flash disk according to claim 1 wherein the public program comprises a time configure module as one timing mechanism which is used to decide time intervals of both the data disks plugged into the electronic data exchange device and the data disks sequentially plugged each other and is provided with a time configure interface exported to an electronic data exchange device.

5. The combinative encryption flash disk according to claim 1 wherein the public program comprises a password configure module which is used to key in or cancel a password and is provided with a password configure interface exported to an electronic data exchange device.

6. The combinative encryption flash disk according to claim 2, 3, 4, or 5 wherein the capacity configure interface, the sequence configure interface, the time configure interface, and the password configure interface can be integrated into an identical operation interface or any of different operation interfaces for performance of each configure.

7. The combinative encryption flash disk according to claim 1 wherein the public program is installed in a single data disk or distributed in one of a plurality of data disks at least.

8. The combinative encryption flash disk according to claim 1 wherein the contact fingers are compatible to one of the following data transfer interfaces at least such as Universal Serial Bus (USB), Mini Universal Serial Bus (Mini USB), Micro Universal Serial Bus (Micro USB), or External Serial Advanced Technology Attachment (e-SATA).

9. A combinative encryption flash disk for digital data encrypted and accessed comprising an operating procedure shown as follows:
Step 1: Two data disks at least provided;
Step 2: Data disks plugged into an electronic data exchange device and sequentially and properly connected each other;
Step 3: Operation interface enabled;
Step 4: Relative capacity of the public zone and the private zone regulated via the operation interface's capacity configure interface;
Step 5: Configuration completed.

10. The combinative encryption flash disk's operating procedure for digital data encrypted and accessed according to claim 9 wherein a sequence of the data disks, time intervals of the data disks sequentially plugged, and key-in as well as cancel of a password can be regulated or configured via the sequence configure interface, the time configure interface, and the password configure interface respectively after Step 3.
